(19) United States
(12) Patent Application Publication
(10) Pub. No.: US 2007/0223064 A1
(43) Pub. Date: Sep. 27, 2007

(54) Image reading apparatus, image processing method and computer-readable recording medium

(75) Inventor: Shuji Ichitani, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA BUSINESS TECHNOLOGIES, INC.

(21) Appl. No.: 11/487,513

(22) Filed: Jul. 17, 2006

(30) Foreign Application Priority Data
Mar. 23, 2006 (JP) JP2006-081468

(51) Int. Cl. H04N 1/40

(52) U.S. Cl. 358/504; 358/461

(57) ABSTRACT

Disclosed is an image reading apparatus, which comprises: (1) an image reading section which scans a calibration sheet for calibration and reads image information thereof; and (2) a correction section which calibrates a brightness tone correction table based on the image information read from the calibration sheet by the image reading section, corrects image information of the calibration sheet using the calibrated brightness tone correction table and calibrates a color correction table based on the corrected image information.

This application is based on Japanese Patent Application No. 2006-081468 filed on Mar. 23, 2006, in Japanese Patent Office, the entire content of which is hereby incorporated by reference.

### TECHNICAL FIELD

The present invention relates to an image reading apparatus for outputting an image signal obtained by reading an image, an image processing method, and a computer-readable recording medium.

### BACKGROUND

Conventionally, a digital color copier for forming a color image on the basis of color document image data obtained by reading a document is widely put into practical use. In this kind of color copier, a color document image is read by a scanner and document image data relating to the document image is stored once in an image memory. Thereafter, for the document image data read from the image memory, the image process is performed and the document image data after the image processing is transferred to a printer. For example, in a printer adopting an electrophotographic method, on a photosensitive drum charged uniformly by a main charger, an electrostatic latent image based on the document image data is formed by an exposure unit using a polygon mirror.

The electrostatic latent image is developed by a developing unit. Such charging, exposure, and development are executed, thus a color toner image formed on the photosensitive drum is transferred to a transfer paper by a transfer unit. The toner image transferred onto a predetermined transfer paper is fixed by a fixing unit. As a result, the image based on the document image data can be formed on the predetermined transfer paper and the document image can be copied. In such a color copier, a scanner is mounted. Or, the scanner is often used by connecting to a color printer.

FIG. 15 is a block diagram showing a constitution example of a scanner 200 relating to a conventional example. The color scanner 200 shown in FIG. 15 is provided with a scanner section 1, a correction section 2′, and a memory section 3.

The scanner section 1 scans a color document, reads an image, and outputs digital image data DR, DG, and DB including signal components of colors R, G, and B. To the scanner section 1, the correction section 2′ is connected and is provided with three shading correction sections 21, 22, and 23 installed for each color and three γ correction tables 24, 25, and 26.

In the correction section 2′, in the ordinary operation mode, the scan data DR, DG, and DB of the document image read by the scanner section 1 are shading-corrected and then are γ-corrected by the γ correction tables 24, 25, and 26. The scan data DR, DG, and DB after the γ correction are stored temporarily in the memory section 3. The scan data DR′, DG′, and DB′ corrected in this way are outputted to a printer and a monitor.

FIG. 16 is a flow chart showing an image processing example during calibration of the γ correction tables of the scanner 200. For example, at Step SD1, the scanner 200 waits for start of the scanner calibration mode. When start of the scanner calibration mode is instructed, at Step SD2, the scanner 200 puts the γ correction tables 24, 25, and 26 into the practical non-operation state and sets so as not to perform the γ correction. Here, the non-operation means to set a linear table having a ratio of an input value to an output value of 1:1 as a γ correction table and includes a case that the γ correction function does not act practically. Hereinafter, setting of putting a physical or functional block into the practical non-operation state is referred to as “through set”. Next, at Step SD3, the scanner 200 executes a reading process of a calibration sheet image not drawn. And, at Step SD4, the scanner 200 executes the calibration process for the γ correction tables 24, 25, and 26.

For example, the scanner 200 extracts R, G, and B values of the gray scale of 32 tones of a calibration chart and R, G, and B values of 125 colors. Here, for the extracted R, G, and B values of the gray scale, a target and a Y value are set and a γ correction coefficient is obtained (refer to FIG. 8). And, Step SD5, the scanner 200 sets the calibrated γ correction tables. By doing this, in the ordinary operation mode, on the basis of the calibrated γ correction tables 24, 25, and 26, the scan data DR, DG, and DB can be γ-corrected.

In relation to this kind of scanner 200, in Japanese Laid-Open Patent Publication No. H06-237373, a color correction method and apparatus by a color scanner are disclosed. According to this scanner, regarding a difference in the reading precision between a reference scanner and a specific scanner, a density correction is executed on the basis of first correction data for converting density data of a document read by the specific scanner to density data of the same document read by the reference scanner, and then regarding a difference in the coloring characteristic of a color document, second correction data independent of the first correction data is set, and the density correction is executed. By doing this, the respective corrections can be executed with high precision, so that an image of good color reproducibility can be obtained.

However, according to the scanner relating to the conventional example and the image processing method thereof, the following problem arises.

i. The γ correction is executed on the basis of the brightness value of the gray scale, and no matrix correction is executed. Therefore, between machines and apparatuses, there is a fear that the color reproducibility may be varied. Further, there is a fear that the color reproducibility may be deteriorated with time degradation.

ii. Further, according to the color scanner as indicated in the Japanese Laid-Open Patent Publication, even if the difference in density data during reading of the document and the difference in the coloring characteristic of the color document can be fit to the reference scanner, the correction data of the reference scanner is not calibrated, so that between machines and apparatuses, there is a fear that the color reproducibility may be varied or the color reproducibility may be deteriorated with time degradation.

### SUMMARY

An object of the present invention is to provide an improved image reading apparatus, image processing method, and a computer-readable medium in terms of the aforementioned problems. Another object of the present invention is to provide an image reading apparatus for reducing color differences between machines and apparatuses regarding the color reproducibility and reducing errors due to time degradation, an image processing method, and a computer-readable recording medium.

In view of forgoing, one embodiment according to one aspect of the present invention is an image reading apparatus, comprising:

an image reading section which scans a calibration sheet for calibration and reads image information thereof; and

a correction section which calibrates a brightness tone correction table based on the image information read from the calibration sheet by the image reading section, corrects image information of the calibration sheet using the calibrated brightness tone correction table and calibrates a color correction table based on the corrected image information.

According to another aspect of the present invention, another embodiment is an image processing method, comprising the steps of:

calibrating a brightness tone correction table based on image information obtained by reading a calibration sheet for calibration;

correcting image information of the calibration sheet using the calibrated brightness tone correction table; and

calibrating a color correction table based on the corrected image information.

According to another aspect of the present invention, another embodiment is a computer-readable recording medium storing a program for making a computer execute a process, the process comprising the steps of:

calibrating a brightness tone correction table based on image information obtained by reading a calibration sheet for calibration;

correcting image information of the calibration sheet using the calibrated brightness tone correction table; and

calibrating a color correction table based on the corrected image information.

### BRIEF DESCRIPTION OF THE DRAWINGS

FIG. 1 is a block diagram showing a constitution example of a scanner 100 as an embodiment.

FIGS. 2(A) to 2(E) are plan views showing a constitution example of a chart 10 for γ correction and color correction table calibration.

FIG. 3(A) is a drawing showing a preparation example of the chart 10 for γ correction table calibration.

FIG. 3(B) is a drawing showing a preparation example of the chart 10 for color correction table calibration.

FIGS. 4(A), 4(B) are conceptual diagrams showing a processing example in the scanner calibration mode and during the shading correction.

FIG. 5(A) is a drawing showing an example of the data acquired at the time of the red shading correction.

FIG. 5(B) is a drawing showing a correction example at the time of the red shading correction.

FIG. 6 is a flow chart (main routine) showing an image processing example (No. 1) of the scanner 100.

FIG. 7 is a flow chart (main routine) showing an image processing example (No. 2) of the scanner 100.

FIG. 8 is a flow chart (sub-routine) showing an image processing example at the time of the γ correction table calibration.

FIG. 9 is a flow chart (sub-routine) showing an image processing example at the time of the color correction table calibration.

FIG. 10 is a drawing showing a relation example between the scanner output value and the tones of R, G, and B before the γ correction.

FIG. 11 is a drawing showing a relation example between the output value (output) and the input value (input) relating to the γ correction tables.

FIG. 12 is a drawing showing a relation example between the target Y value and the tone thereof.

FIG. 13 is a drawing showing a relation example between the target Y′ value and the tone thereof.

FIG. 14 is a drawing showing a relation example between the scanner output value after the γ correction and the tones of R, G, and B.

FIG. 15 is a block diagram showing a constitution example of the scanner 200 relating to the conventional example.

FIG. 16 is a flow chart showing an image processing example of the scanner 200.

### DETAILED DESCRIPTION OF THE PREFERRED EMBODIMENT

Hereinafter, with reference to the accompanying drawings, the image reading apparatus, image processing method, and computer-readable recording medium relating to the embodiment of the present invention will be explained.

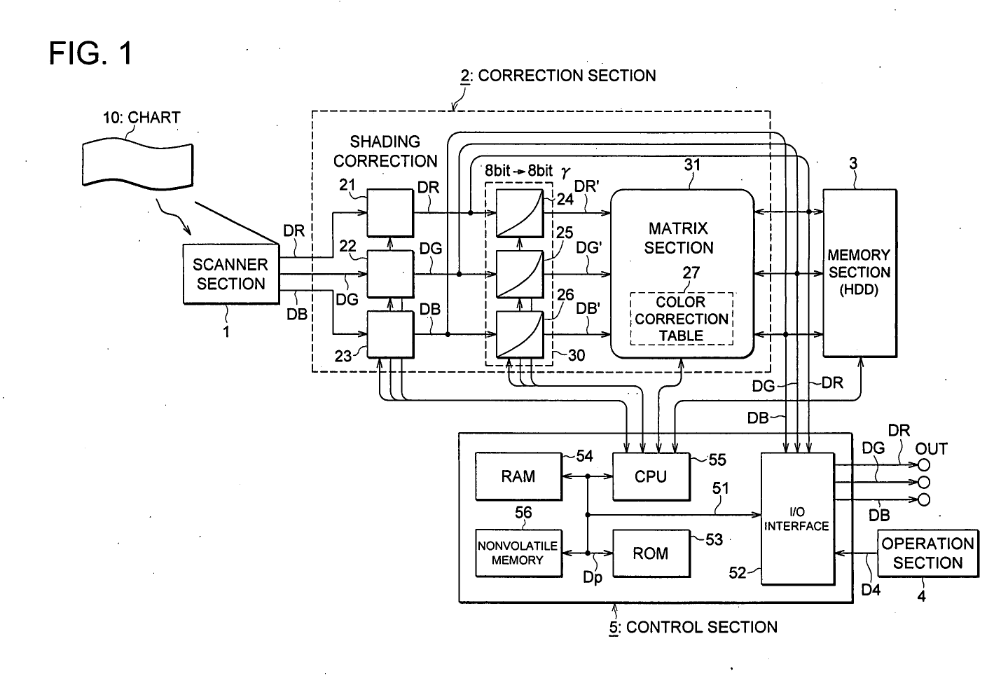

FIG. 1 is a block diagram showing a constitution example of the scanner 100 as an embodiment. The scanner 100 shown in FIG. 1 forms an example of the image reading apparatus and is provided with a scanner section 1, a correction section 2, a memory section 3, an operation section 4, and a control section 5.

The control section 5 includes a system bus 51, an I/O interface 52, a ROM (read only memory) 53, a RAM (random access memory) 54, a CPU (central processing unit) 55, and a nonvolatile memory 56. The I/O interface 52, ROM 53, RAM 54, CPU 55, and nonvolatile memory 56 are connected via the system bus 51. The ROM 53 stores system program data Dp for controlling the whole scanner. The RAM 54 is used as a work memory and for example, stores temporarily a control command. The CPU 55, when the power is turned on, reads the system program data Dp from the ROM 53 into the RAM 54, thereby starts the system, and controls the whole scanner on the basis of operation data D4 from the operation section 4.

The operation section 4 connected to the I/O interface 52 is operated when selecting (setting) either of the ordinary mode and scanner calibration mode. Here, the scanner calibration mode is referred to as an operation of calibrating a brightness tone correction (hereinafter, referred to as γ correction) table by image data (hereinafter, referred to as scan data DR, DC, and DB) after the shading correction, correcting scan data of a calibration sheet by the calibrated brightness tone correction table, and calibrating the color correction table on the basis of the scan data corrected by the γ correction table.

Further, the ordinary operation mode is referred to as operations other than the scanner calibration mode and is referred to as an operation of scanning a document, reading an image, and outputting image data R, G, and B including color signal components of R, G, and B. For the operation section 4, for example, an operation panel of a GUI (graphic user interface) type provided with a touch panel and a liquid crystal display panel is used. In this example, the set contents of the correction section 2 (ASIC: Application Specific Integrated Circuit) of each scan are shown in Table 1.

TABLE 1

| | γ | Matrix |
|---|---|---|
| First scan during collection | Through (OFF) | Unit matrix (OFF) |
| (for γ correction) | | |
| Second scan during correction | ON | Unit matrix (OFF) |
| (for matrix correction) | | |
| During ordinary scan | ON | ON |

According to Table 1, in the first scan in the scanner calibration mode, both the γ correction table and color correction table are through-set. Further, as mentioned above, through set means setting of putting a physical or functional block into the practical non-operation state. Further, within the range of this meaning, the non-operation includes a case that a linear parameter realizing a ratio of an input value to an output value of 1:1 is set in a block, thus the function of the concerned block does not act practically. The second scan at time of the calibration turns on the γ correction table. Both the γ correction table and color correction table (matrix) are set to be turned on at the time of the ordinary scan. In this example, the second scan does not read again the calibration chart 10 but uses again the raw data of the first scan stored in the memory section 3. Needless to say, a constitution for reading again the calibration chart 10 on the platen may be used.

The control section 5 aforementioned, for example, when the scanner calibration mode is set, calibrates the γ correction table and color correction table on the basis of the scan data of R, G, and B obtained by the scanner section 1. Further, the control section 5 sets the calibrated brightness tone correction table and calibrated color correction table and controls the correction section 2.

In this example, the nonvolatile memory 56 is connected to the control section 5 via the system bus 51 and stores reference measured values (reference X, Y, and Z values, reference values) obtained by calorimetrically measuring the calibration chart 10 beforehand. The reference X, Y, and Z values are measured beforehand before shipment, for example, by using a reference calorimeter by a manufacturer. The reference X, Y, and Z values may be recorded (stored) in the memory 3 of the scanner 100 by data transfer input or manual input instead of the nonvolatile memory 56. For the nonvolatile memory 56, an EEPROM and a hard disk (HDD) are used.

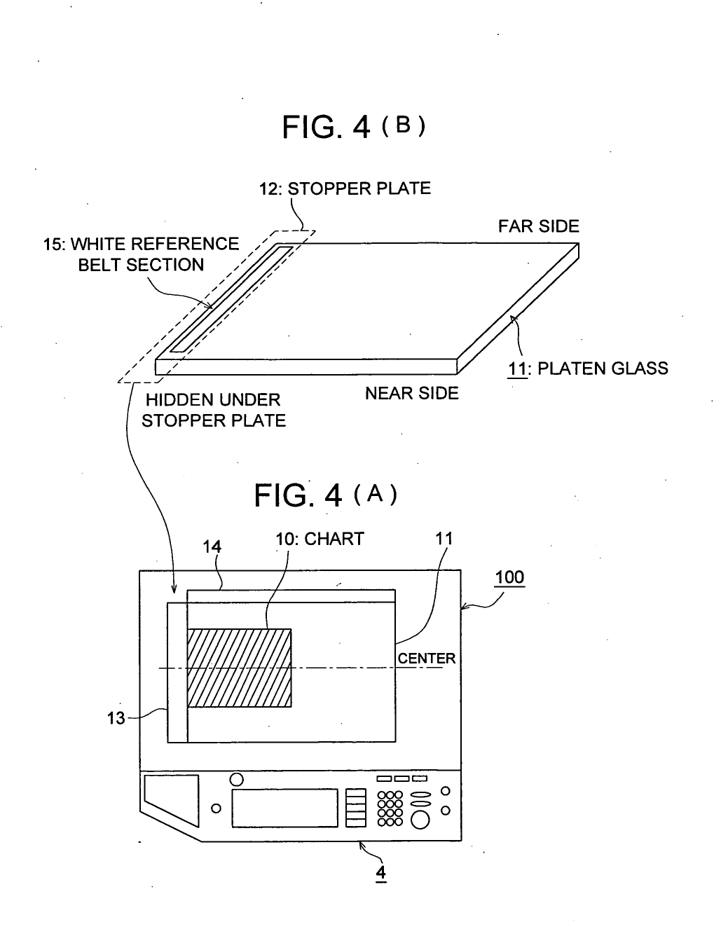

The scanner section 1 scans a document such as the calibration chart 10 to read an image thereof, and outputs digital image data (hereinafter, referred to as scan data) DR, DG, and DB including color signal components of R, G, and B. For a calibration sheet, the chart 10 for calibrating the brightness tone correction table and color correction table is used (refer to FIG. 4(A)).

The scanner section 1 is connected to the correction section 2. The correction section 2 includes a γ correction section 30 provided with an image processing circuit having a set of three shading correction sections 21, 22, and 23 installed for each color and three γ correction tables 24, 25, and 26 and a matrix section 31 having a set of a color correction table 27. The correction section 2, in the scanner calibration mode, calibrates the γ correction tables 24, 25, and 26 on the basis of the scan data DR, DG, and DB of the calibration sheet read by the scanner section 1, corrects the scan data of the concerned sheet by the calibrated γ correction tables 24, 25, and 26, and calibrates the color correction table 27 on the basis of the scan data DR′, DG′, and DB′ corrected by the γ correction tables.

The shading correction section 21, in the ordinary operation mode and scanner calibration mode, shading-corrects image data R including a red component signal and outputs scan data DR. The shading correction section 22 similarly shading-corrects image data G including a green component signal and outputs scan data DG. The shading correction section 23 similarly shading-corrects image data B including a blue component signal and outputs scan data DB.

In this example, in the scanner calibration mode, the scan data DR, DG, and DB after the shading correction are temporarily stored in the memory section 3 with the γ correction tables 24, 25, and 26 and color correction table 27 through-set. In the ordinary operation mode, the scan data DR, DG, and DB are respectively γ corrected, so that they are straight outputted to the γ correction tables 24, 25, and 26 (the γ correction section 30).

The shading correction section 21 is connected to the γ correction table 24 for red and the γ correction table 24, in the scanner calibration mode, is calibrated on the basis of the scan data DR including the red signal component after the shading correction. The shading correction section 22 is connected to the γ correction table 25 for green and the γ correction table 25, in the scanner calibration mode, similarly to red, is calibrated on the basis of the scan data DG including the green signal component. The shading correction section 23 is connected to the γ correction table 26 for blue and the γ correction table 26, in the scanner calibration mode, similarly to red and green, is calibrated on the basis of the scan data DB including the blue signal component. The scan data DR, DG, and DB after the γ correction process in the ordinary operation mode are outputted straight to the color correction table 27.

The γ correction section 30 is connected to the matrix section 31 where the color conversion table 27 is set. The color conversion table 27 of the matrix section 31, in the scanner calibration mode, is calibrated on the basis of the scan data DR, DG, and DB after γ-corrected by the calibrated γ correction tables 24, 25, and 26.

The color correction table 27, assuming the red input value as InRed, the green input value as InGreen, the blue input value as InBlue, the matrix coefficients as A11, A12, A13, A21, A22, A23, A31, A32, and A33, the constants as C1, C2, and C3, the red output value as OutRed, the green output value as OutGreen, and the blue output value as OutBlue, is calculated by Formula (1) indicated below.

$$\begin{matrix}[ Formula 1 ] & \\ ( \begin{matrix}OutRed \\ OutGreen \\ OutBlue\end{matrix} ) = ( \begin{matrix}{A}_{11} & {A}_{12} & {A}_{13} \\ {A}_{21} & {A}_{22} & {A}_{23} \\ {A}_{31} & {A}_{32} & {A}_{33}\end{matrix} ) \times ( \begin{matrix}InRed \\ InGreen \\ InBlue\end{matrix} ) + ( \begin{matrix}{C}_{1} \\ {C}_{2} \\ {C}_{3}\end{matrix} ) & ( 1 )\end{matrix}$$

In the ordinary operation mode, the color correction table 27 performs the color correction process for the scan data DR, DG, and DB after the γ correction. The scan data DR, DG, and DB after the color correction process are outputted to the memory section 3.

The memory section 3, in the scanner calibration mode, stores temporarily the scan data DR, DG, and DB after the shading correction of the calibration sheet read by the scanner section 1 or in the ordinary operation mode, to output the scan data DR, DG, and DB after the color correction process to a printer not drawn, stores temporarily the scan data DR, DG, and DB. For the memory section 3, a DRAM (Dynamic Random Access Memory) or a HDD (Hard Disc Drive) is used.

By doing this, in the scanner calibration mode, the scan data DR, DG, and DB of the calibration sheet 10 read from the memory section 3 are corrected by the calibrated γ (brightness tone) correction tables 24, 25, and 26 and the color correction table 27 can be calibrated by the scan data DR, DG, and DB after the correction. Further, the correction section 2, in the ordinary operation mode, corrects the scan data DR, DG, and DB by the calibrated γ correction tables and the calibrated color correction table both set by the control section 5. The scan data DR, DG, and DB corrected like this are outputted to the printer via the I/O interface 52.

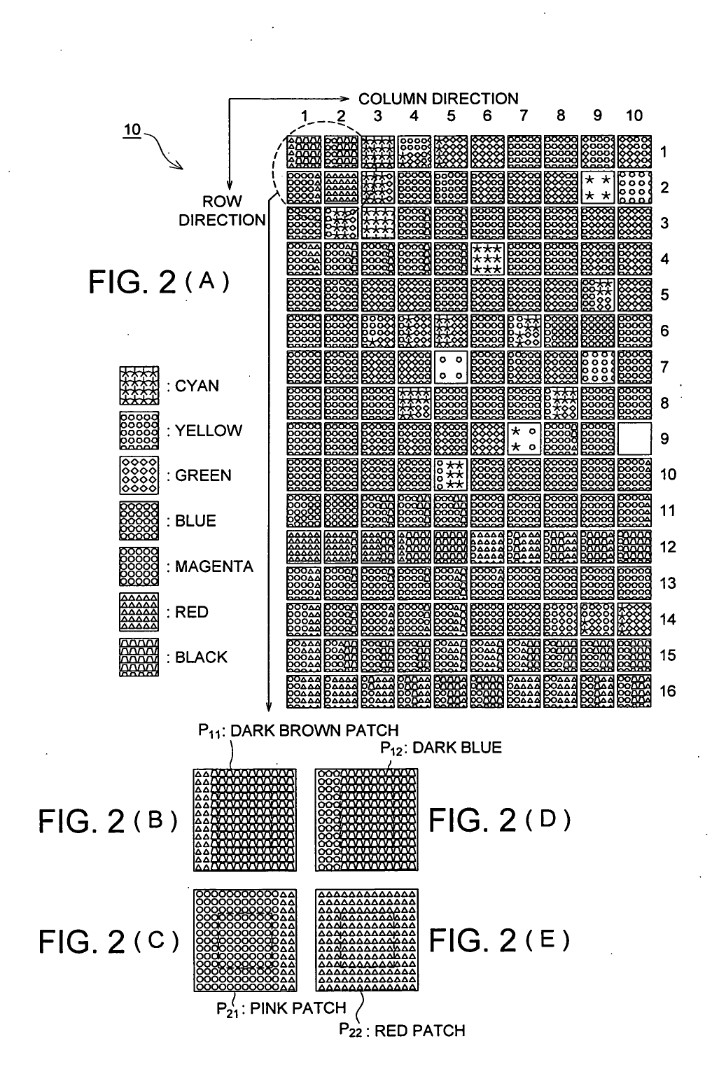

FIGS. 2(A) to 2(E) are plan views showing constitution examples of the chart 10 for γ correction and color correction table calibration.

The chart 10 for γ correction and color correction table calibration shown in FIG. 2(A) is formed by arranging a gray scale of 32 tones and 125-color patches patch by patch at random in a matrix shape by 10 pieces×16 pieces in the column direction×row direction. The correction section 2 shown in FIG. 1, on the basis of the brightness information obtained by reading the gray scale, calibrates the γ correction tables 24, 25, and 26 and on the basis of the color scan data obtained by reading the color patches, calibrates the color correction table 27.

FIGS. 2(B) to 2(E) are enlarged views of the four picked-up patches of the patch Nos. 1 and 2 in the column direction and the patch Nos. 1 and 2 in the row direction. P₁₁ shown in FIG. 2(B) indicates a dark brown patch, and P₁₂ a dark blue patch, P₂₁ a pink patch, and P₂₂ a red patch. In each of the patches P₁₁, P₁₂, P₂₁, and P₂₂, the dotted lines in the patch indicate the R, G, and B extracted areas, and the R, G, and B values of each pixel in the R, G, and B extracted areas are averaged as R, G, and B values of the concerned patch.

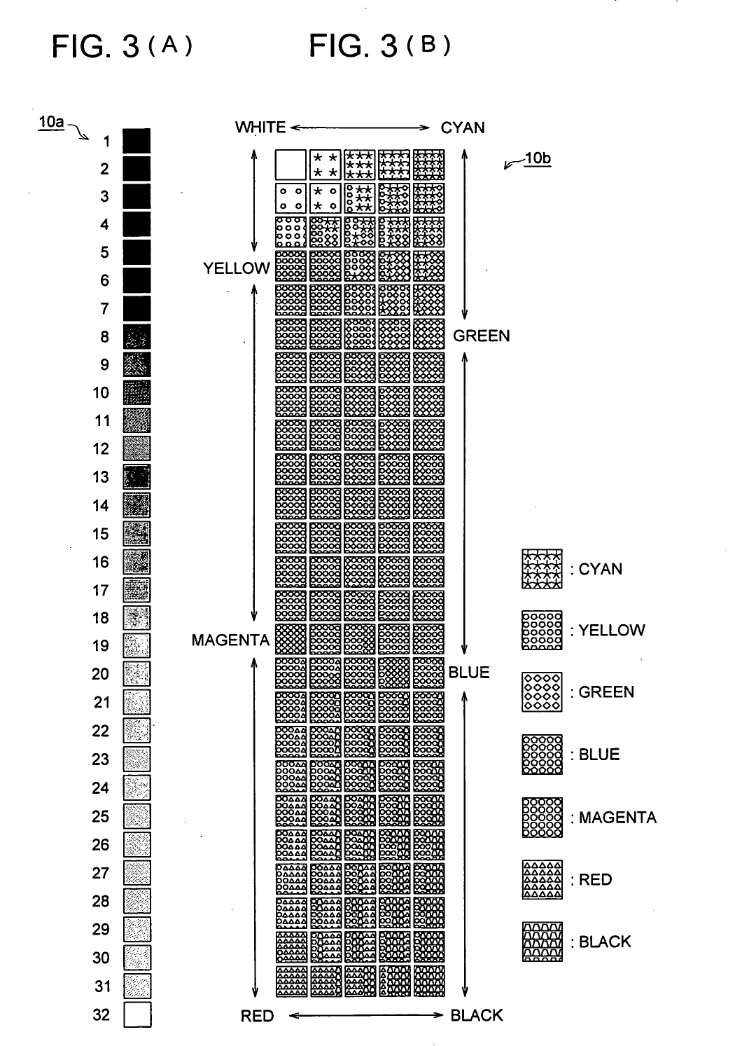

FIGS. 3(A) and 3(B) are drawings respectively showing preparation examples of the chart 10 for γ correction and color correction table calibration.

The chart 10a for γ correction table calibration shown in FIG. 3(A) shows a gray scale of 32 tones. In the chart 10a, for example, the 32nd tone is white, and the first tone is black, and between the first tone and the 32nd tone, the second tone to the 31 st tone are a gray scale in which the rate white and black are changed.

The chart 10b for color correction table calibration shown in FIG. 3(B) shows 125 colors of R, G, B, C, M, and Y. In the chart 10b, for example, the upper left corner is white, and the upper right corner is cyan (C), and between them, the chromaticity is changed from white to cyan. Further, the lower left corner is red (R), and the lower right corner is black (K), and between them, the chromaticity is changed from red to black. Between white and red on the left end side, from above, the chromaticity is changed from yellow (Y) to magenta (M). Between cyan and black on the right end side, from above, the chromaticity is changed from green (G) to blue (B).

Using the charts 10a and 10b, the calibration chart 10 as shown in FIG. 2(A) is formed. For example, the gray scale of 32 tones of the chart 10a is separated into 32 pieces for each tone. Further, the 125 color patches of the chart 10b are separated into 125 pieces patch by patch. Thereafter, at random on a predetermined sheet of paper, 32 gray scale patches and 125 color patches for column direction×row direction=10 pieces×16 pieces are arranged (adhered) in a matrix shape. By doing this, the chart 10 for γ correction and color correction table calibration as shown in FIG. 2(A) can be formed.

In this example, the chart 10 is measured by a calorimeter and for example, X, Y, and Z values are obtained as colorimetrical measurement information. Needless to say, such information is not limited to X, Y, and Z values and the subsequent process may be performed by other Lab values and density. The X, Y, and Z values of 0.0 to 1.0 are stored beforehand in the memory section 3 of the scanner 100 or the nonvolatile memory 56 in the control section 5.

Then, the image processing method of the scanner 100 as an embodiment will be explained. FIGS. 4(A) and 4(B) are conceptual diagrams showing processing examples in the scanner calibration mode and in the shading correction. The scanner 100 shown in FIG. 4(A) has a platen glass 11. At the left end and upper end of the platen glass 11, scale plates 13 and 14 are arranged. In this example, in the scanner calibration mode, the calibration chart 10 explained in FIGS. 2(A) to 2(E) is positioned almost at the middle of the platen glass 11 and is arranged so as to meet the scale plate 13 at the left end not slantwise.

Further, from near side to the far side at the left end of the platen glass 11 shown in FIG. 4(B) and under a stopper plate 12 (at the front end of the scanner glass), a white reference belt section 15 is arranged. The white reference belt section 15, for example, is provided with belt-shaped white paper and at the time of the shading correction (white correction), reflects light irradiated from the light source.

In this embodiment, the scanner 100, during scanning, executes the shading correction process every time. At that time, the scanner 100 irradiates light to the white reference belt section 15 at the front end, reads it, and optimizes the correction level in the main scanning direction. For example, when the read value of the white reference belt section 15 is 200 tones at 1 pixel in the main scanning direction, the CCD output value of the pixel in the sub-scanning direction is corrected by being multiplied by 255/200 tone.

Further, when the read value is 260 tones, the CCD output value is corrected by being multiplied by 255/260 tone. These correction contents are on the assumption that the image data R, G, and B are 8 bits long. Therefore, variations in the brightness of the light source can be shading-corrected. This shading correction is always executed not only in the ordinary operation mode but also in the scanner calibration mode which will be explained below.

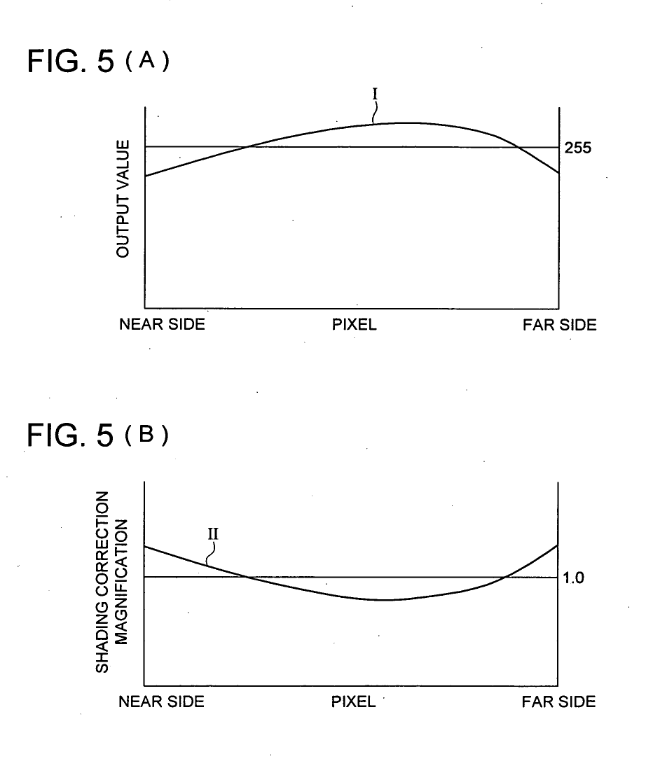

FIGS. 5(A) and 5(B) are drawings respectively showing a data acquisition example and a correction example thereof during the red shading correction. In FIGS. 5(A) and 5(B), the axis of abscissa indicates pixels, and the left side of the drawing is the position equivalent to near side of the platen, and the right side of the drawing is the position equivalent to the far side of the platen. The axis of ordinate shown in FIG. 5(A) indicates an output value (0 to 255 tones). I shown in the drawing indicates an uneven light quantity curve, which is curved convexly upward. The uneven light quantity curve I can be obtained, for example, by irradiating light to the white reference belt section 15 and plotting scan data obtained by reading it from near side of the platen to the far side thereof.

II shown in the drawing indicates a shading correction curve. The axis of ordinate shown in FIG. 5(B) indicates a magnification of shading correction. In the shading correction process, by the concave shading correction curve based on a magnification of 1.0 shown in FIG. 5(B), the convex uneven light quantity curve I shown in FIG. 5(A) is corrected so as to control the magnification to 1.0. G (green) and B (blue) are also shading-corrected similarly.

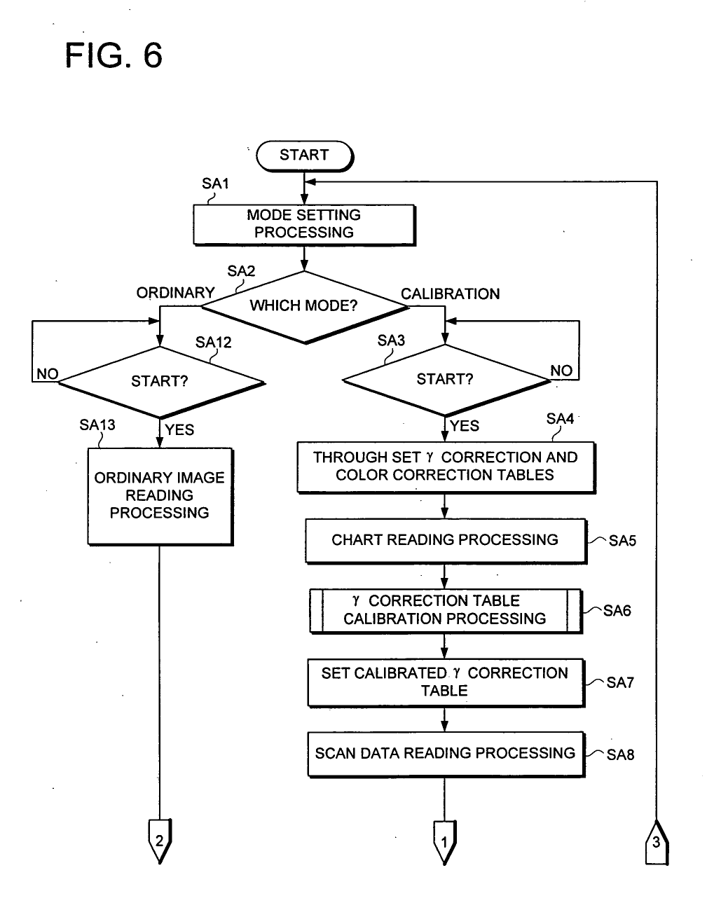

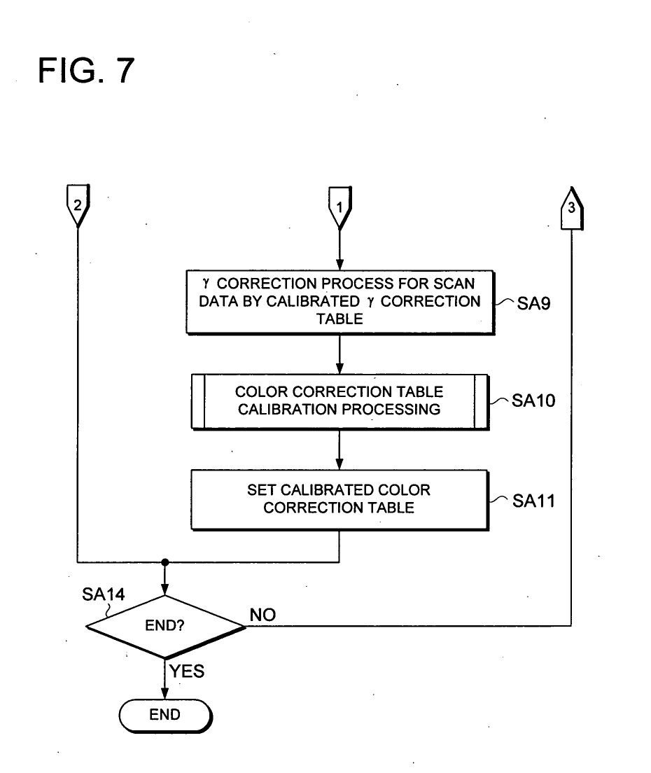

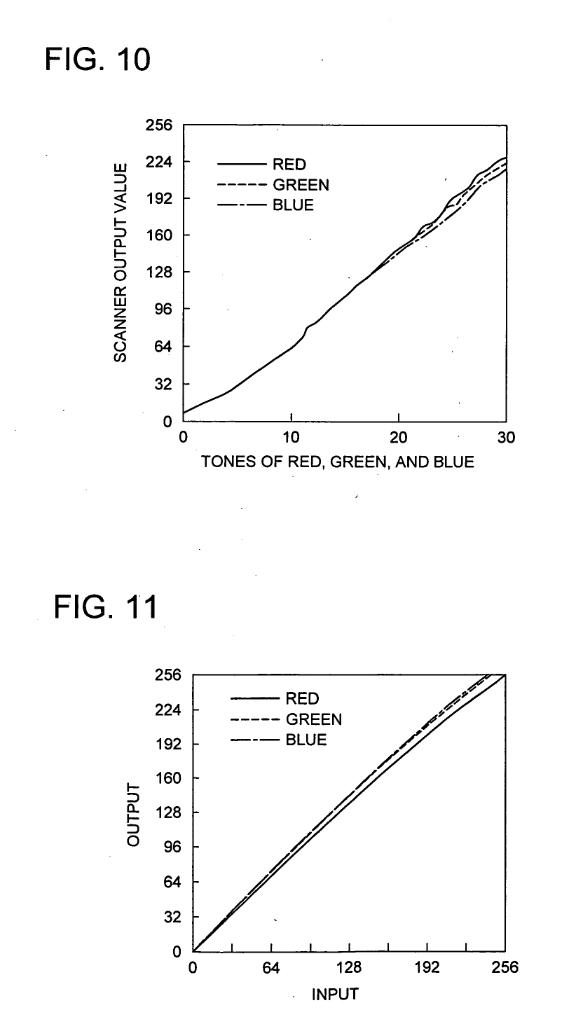

FIGS. 6 to 9 are flow charts showing image processing examples of the scanner 100 and FIGS. 10 to 14 are graph drawings for supplementing the image processing examples before and after the γ correction.

FIG. 10 is a drawing showing a relation example between the scanner output value of 32 tones before the γ correction and the tone of R, G, and B values. The axis of ordinate indicates the scanner output values=0 to 255 tones. The axis of abscissa indicates 0 to 32 tones of the R, G, and B values. The solid line indicates the characteristic of red, and the dashed line indicates the characteristic of green, and the alternate long and short dash line indicates the characteristic of blue. According to the scanner 100 of 32 tones before the γ correction, as the tone number increases, the γ correction tables of R, G, and B are varied and opened due to the change with time.

FIG. 11 is a drawing showing a relation example between the output value output and the input value input relating to the γ correction tables. The axis of ordinate indicates a scanner output value output=0 to 255 tones. The axis of abscissa indicates a scanner input value input=0 to 255 tones. The solid line indicates the γ correction characteristic of red, and the dashed line indicates the γ correction characteristic of green, and the alternate long and short dash line indicates the γ correction characteristic of blue. According to the scanner 100 of 32 tones before the γ correction, as the tone number increases, the γ correction tables of R, G, and B are varied and opened due to the change with time.

In this embodiment, the chart 10 for γ correction and color correction table calibration in which the gray scale and color patches shown in FIG. 2(A) are arranged at random on one chart is prepared. When executing the scanner calibration mode, on the basis of the brightness data (Y value) obtained by reading the gray scale of 32 tones of the calibration chart 10, the scanner calibrates (resets, re-prepares) the γ correction tables 24, 25, and 26.

In this example, during the color correction table calibration, the scan data DR, DG, and DB obtained by reading the 125 color patches are corrected by the calibrated γ correction tables 24, 25, and 26. Furthermore, the color correction table 27 is calibrated by the scan data DR′, DG′, and DB′ after correction. And, in the ordinary operation mode, new γ correction tables 24, 25, and 26 after the scanner calibration mode as shown in FIG. 14 and the calibrated color correction table 27 are set and by the newly set γ correction tables 24, 25, and 26 and color correction table 27, the scan data DR, DG, and DB at time of ordinary image reading are corrected.

Under these calibration processing conditions, the mode setting process is executed at Step SA1 of the flow chart shown in FIG. 6. At this time, a user operates the operation section 4 and sets the ordinary operation mode or scanner calibration mode in the control section 5. When executing copying in the ordinary operation mode, an ordinary document not drawn is loaded on the platen glass. When setting the scanner calibration mode, the user, as shown in FIG. 4(A), loads the calibration chart 10 as a document at a predetermined position on the platen glass 11.

Next, at Step SA2, the control section 5 branches the control on the basis of selection of the ordinary operation mode or scanner calibration mode. When the scanner calibration mode is selected, the control section 5 moves to Step SA3 and waits for a start instruction. The start instruction is set by operating the operation section 4 by the user, thereby inputting the operation data D4 to the control section 5.

When the start instruction is input to the control section 5, the control section 5 moves to Step SA4. The control section 5 through-sets the γ correction tables 24, 25, and 26 and color correction table 27 and executes the shading correction process. For example, the scanner section 1 outputs the scan data DR, DG, and DB after converting R, G, and B signals of the N value of three or more colors from analog to digital to the shading correction sections 21, 22, and 23.

When shading-correcting, for example, the red scan data DR by the shading correction section 21, the control section 5 irradiates light to the white reference belt section 15 shown in FIG. 4(B), reads it, and obtains the scan data DR. When the scan data DR is stored in the memory and is plotted from near side of the platen to the far side of thereof, the convex uneven light quantity curve I as shown in FIG. 5(A) is obtained. The uneven light quantity curve I is corrected by the linearly symmetrical concave shading correction curve II as shown in FIG. 5(B). The green and blue scan data DG and DB are similarly shading-corrected.

In this state, at Step SA5, the control section 5 scans the calibration chart 10, thereby obtains (reads) the scan data DR, DG, and DB. The scan data DR, DG, and DB are stored in the memory section 3 through the γ correction tables 24, 25, and 26 and color correction table 27. By doing this, the scan data DR, DG, and DB of the brightness values of 0 to 255 tones based on the magnification 1.0 can be obtained by the shading correction sections 21, 22, and 23.

[Calibration Process for γ Correction Tables]

Next, at Step SA6, the control section 5 calibrates the γ correction tables 24, 25, and 26. The γ correction tables 24, 25, and 26 can be obtained from the measured color values at several stages of the gray scale and the output values from the scanner section 1. For the output values from the scanner section 1, the scan data DR, DG, and DB after the shading correction which are read from the memory section 3 are used.

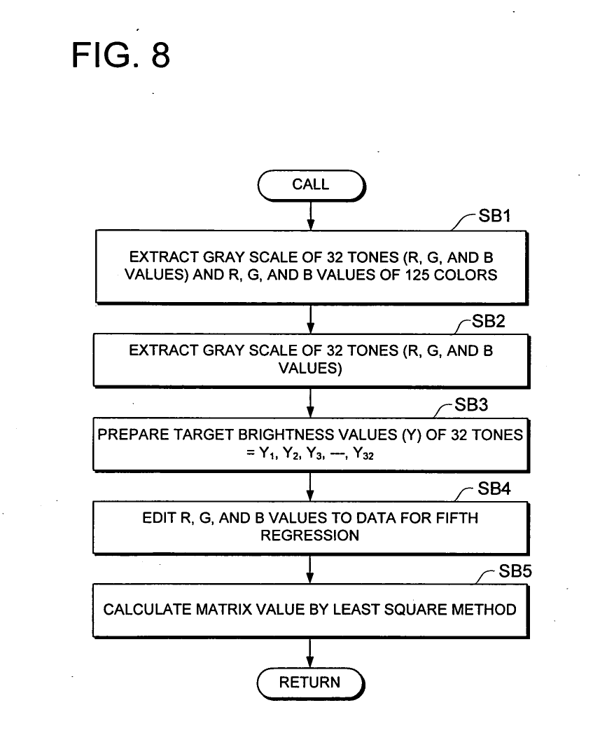

For example, the control section 5 calls the sub-routine shown in FIG. 8 and extracts, at Step SB1 of the flow chart, the R, G, and B values of the gray scale in correspondence to 32 tones of the calibration chart 10 and the R, G, and B values of 125 colors. At this time, the control section 5 averages the brightness values of the pixels in a predetermined R, G, and B extraction areas (dimensions) of each patch of the calibration chart image in the memory section, thereby obtains the R, G, and B values of each patch. The R, G, and B extraction areas of the chart image are indicated by the dashed lines in FIGS. 2(B) to 2(E).

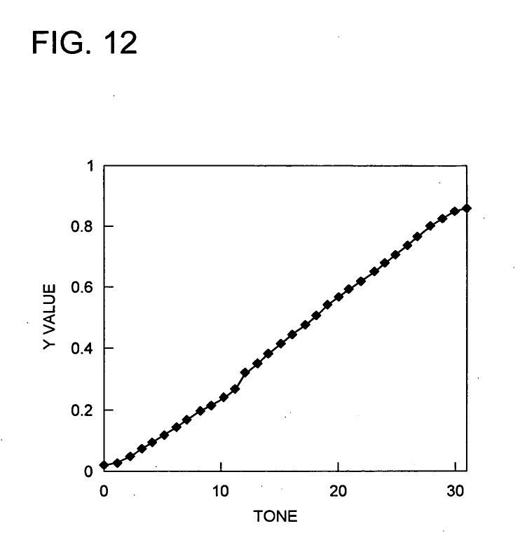

Next, at Step SB2, the control section 5 takes out the R, G, and B values in correspondence to the gray scale of 32 tones from the 32 tones plus the R, G, and B values of 125 colors of the calibration chart 10. Thereafter, at Step SB3, the control section 5 prepares the target of 32 tones and brightness values (Y=Y₁, Y₂, Y₃, - - - , Y₃₂) thereof. FIG. 12 is a drawing showing a relation example between the target Y value and the tone thereof. The axis of ordinate indicates the target values 0 to 1.0 and the axis of abscissa indicates the target 0 to 32 tones. The solid line of black square marks indicates the brightness characteristic of the target.

Here, for the brightness values Y₁, Y₂, Y₃, - - - , and Y₃₂ of the target, the mean R, G, and B values are used. In this example, the control section 5, from the X, Y, and Z values at time of calorimetric measurement supplied beforehand to the scanner section 1, takes out the brightness value (Y value) of the gray scale. By fitting the scan data DR, DG, and DB to the target, the gray scale can be calibrated in response to the inter-machine difference and change with time.

[Calculation of γ Correction Coefficient]

For example, from the R, G, and B values and target Y value of the gray scale, the γ correction coefficients a, b, c, d, e, and f of each color are obtained. Here, the tone correction algorithm will be explained. According to the tone correction algorithm, firstly, when the scan data DR, DG, and DB are 8 bits long and the gray scale is represented by 32 tones, there are R, G, and B values of the gray scale of 32 tones and a target Y value of 32 tones.

Here, assuming the brightness value of “white” at time of shading correction as Yw, the Y value of the gray scale of 32 tones is normalized to 255 tones by the brightness value Yw of white at time of shading correction. Namely, assuming the brightness value of the gray scale of 32 tones after normalization as a Y′ value, it is obtained from Formula (2) indicated below.

$$\begin{matrix}[ Formula 2 ] & \\ {Y}^{′} = \frac{Y}{Yw} \times 255 & ( 2 )\end{matrix}$$

(where Yw indicates a Y value of white reference and Y indicates respective values of 32 tones.)

In Formula (2), the Y value of white reference is substituted for Yw and the respective values of 32 tones are substituted for Y.

In this example, the γ correction tables 24, 25, and 26, so that the brightness data (0.9391) of YUPO paper becomes 255 tones, normalizes the brightness data (0.0 to 1.0) among the X, Y, and Z values, at time of calorimetric measurement, of 32 tones of the gray scale preserved in the nonvolatile memory 56.

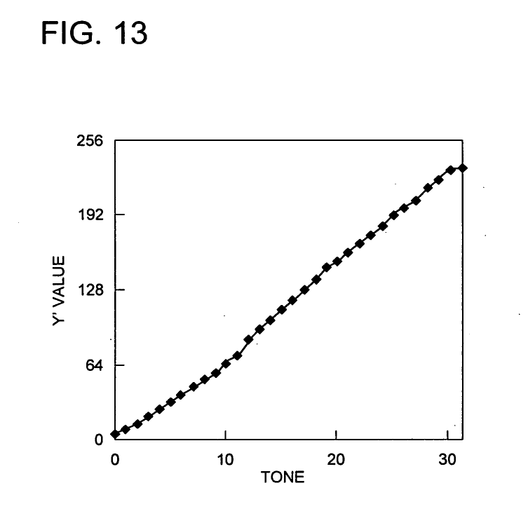

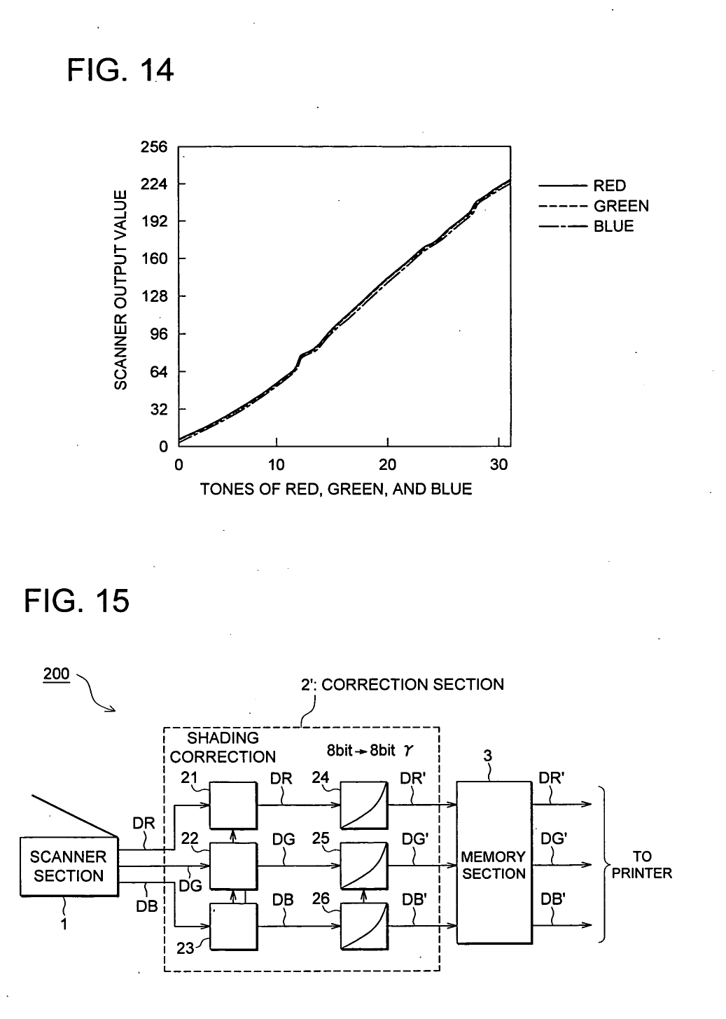

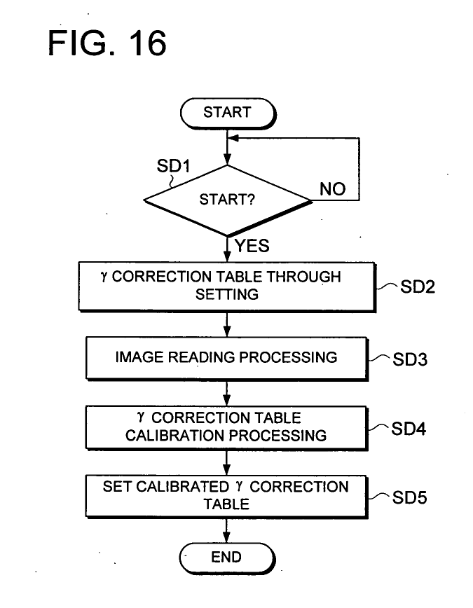

Further, FIG. 13 shows a drawing that the Y value of the gray scale of 32 tones is normalized to 255 tones by the brightness value Yw of white at time of shading correction. FIG. 13 is a drawing showing a relation example between the target Y′ value of 32 tones and the tone thereof. The axis of ordinate indicates the target Y′ value=0 to 255 tones and the axis of abscissa indicates the target 0 to 32 tones. The solid line of black square marks indicates the brightness characteristic of the target after normalization.

The R, G, and B values of 32 tones of the gray scale obtained from the scanner section 1 are used for calculation for each channel for R, G, and B. For example, 32 tones of red are taken out and the red channels of 32 tones are set as R₁, R₂, R₃, - - - , and R₃₂. The green channels are set as G₁, G₂, G₃, - - - , and G₃₂ and the blue channels are set as B₁, B₂, B₃, - - - , and B₃₂. The R, G, and B values of 32 tones are expressed by Formula (3) indicated below.

$$\begin{matrix}[ Formula 3 ] & \\ ( \begin{matrix}{R}_{1} , & {R}_{2} , … , {R}_{32} \\ {G}_{1} , & {G}_{2} , … , {G}_{32} \\ {B}_{1} , & {B}_{2} , … , {B}_{32}\end{matrix} ) & ( 3 )\end{matrix}$$

Next, at Step SB4, the control section 5 changes (executes) the R, G, and B values of 32 tones of the gray scale for fifth regression. Assuming the red after increasing for the fifth regression as R⁰, R¹, R², R³, R⁴, and R⁵, they are obtained from Formula (4) indicated below.

$$\begin{matrix}[ Formula 4 ] & \\ \begin{matrix}{R}^{0} = O \\ {R}^{1} = R \\ {R}^{2} = R \times R \\ {R}^{3} = R \times R \times R \\ {R}^{4} = R \times R \times R \times R \\ {R}^{5} = R \times R \times R \times R \times R\end{matrix} \} & ( 4 )\end{matrix}$$

Therefore, the red data are increased to the data number of 6 times from 0th power to fifth power. The values of green and blue are also increased for fifth regression.

When the red values increased for fifth regression by Formula (4) indicated above are expressed by 32 tones, Formula (5) indicated below is obtained.

$$\begin{matrix}[ Formula 5 ] & \\ ( \begin{matrix}{R}_{1}^{0} & {R}_{2 }^{0} … {R}_{32}^{0} \\ {R}_{1}^{1} & {R}_{2 }^{1} … {R}_{32}^{1} \\ {R}_{1}^{2} & {R}_{2 }^{2} … {R}_{32}^{2} \\ {R}_{1}^{3} & {R}_{2 }^{3} … {R}_{32}^{3} \\ {R}_{1}^{4} & {R}_{2 }^{4} … {R}_{32}^{4} \\ {R}_{1}^{5} & {R}_{2 }^{5} … {R}_{32}^{5}\end{matrix} ) & ( 5 )\end{matrix}$$

Here, assuming the target brightness values Y′ as Y′1, Y′₂, Y′₃, - - - , and Y′₃₂ and the fifth regression coefficients (the γ correction coefficients) as a, b, c, d, e, and f, between the target brightness value Y′ and the red value of 32 tones, Formula (6), that is, the determinant indicated below is obtained.

$$\begin{matrix}[ Formula 6 ] & \\ ( {Y}_{1}^{′} {Y}_{2}^{′} … {Y}_{32}^{′} ) = ( a b c d e f ) \cdot ( \begin{matrix}{R}_{1}^{0} , & {R}_{2}^{0} , … , {R}_{32}^{0} \\ {R}_{1}^{1} , & {R}_{2}^{1} , … , {R}_{32}^{1} \\ {R}_{1}^{2} , & {R}_{2}^{2} , … , {R}_{32}^{2} \\ {R}_{1}^{3} , & {R}_{2}^{3} , … , {R}_{32}^{3} \\ {R}_{1}^{4} , & {R}_{2}^{4} , … , {R}_{32}^{4} \\ {R}_{1}^{5} , & {R}_{2}^{5} , … , {R}_{32}^{5}\end{matrix} ) & ( 6 )\end{matrix}$$

From the determinant, the γ correction coefficients=a, b, c, d, e, and f can be obtained.

In this example, the control section 5 moves up to Step SB5 and obtains the fifth regression coefficients a, b, c, d, e, and f from Formula (7) indicated below by

$$\begin{matrix}[ Formula 7 ] & \\ \begin{matrix}( a b c d e f ) = ( {Y}_{1}^{′} {Y}_{2}^{′} … {Y}_{32}^{′} ) \cdot \\ ( \begin{matrix}{R}_{1}^{0} & {R}_{1}^{1} & {R}_{1}^{2} & {R}_{1}^{3} & {R}_{1}^{4} & {R}_{1}^{5} \\ {R}_{2}^{0} & {R}_{2}^{1} & {R}_{2}^{2} & {R}_{2}^{3} & {R}_{2}^{4} & {R}_{2}^{5} \\ … & … & … & … & … & … \\ {R}_{32}^{0} & {R}_{32}^{1} & {R}_{32}^{2} & {R}_{32}^{3} & {R}_{32}^{4} & {R}_{32}^{5}\end{matrix} ) \cdot \\ ( ( \begin{matrix}{R}_{1}^{0} & {R}_{2}^{0} … {R}_{32}^{0} \\ {R}_{1}^{1} & {R}_{2}^{1} … {R}_{32}^{1} \\ {R}_{1}^{2} & {R}_{2}^{2} … {R}_{32}^{2} \\ {R}_{1}^{3} & {R}_{2}^{3} … {R}_{32}^{3} \\ {R}_{1}^{4} & {R}_{2}^{4} … {R}_{32}^{4} \\ {R}_{1}^{5} & {R}_{2}^{5} … {R}_{32}^{5}\end{matrix} ) \cdot \\ { ( \begin{matrix}{R}_{1}^{0} & {R}_{1}^{1} & {R}_{1}^{2} & {R}_{1}^{3} & {R}_{1}^{4} & {R}_{1}^{5} \\ {R}_{2}^{0} & {R}_{2}^{1} & {R}_{2}^{2} & {R}_{2}^{3} & {R}_{2}^{4} & {R}_{2}^{5} \\ … & … & … & … & … & … \\ {R}_{32}^{0} & {R}_{32}^{1} & {R}_{32}^{2} & {R}_{32}^{3} & {R}_{32}^{4} & {R}_{32}^{5}\end{matrix} ) )}^{- 1}\end{matrix} & ( 7 )\end{matrix}$$

The CPU 55 processes the 32 target data and 32×6 scan data DR′, DG′, and DB′ by the least square method and obtains the fifth regression coefficients a, b, c, d, e, and f. The fifth regression coefficients a, b, c, d, e, and f are used as a γ correction coefficient.

Here, assuming the γ correction coefficients as a, b, c, d, e, and f and the constant as i, the output value Out of the γ correction table of each color is calculated by Formula (8) indicated below.

[Formula 8]
0ut=a×i⁰+b×i¹+c×i²+d×i³+e×i⁴+f×i⁵ (8)

(where 0 to 255 are substituted for i.)

Further, the values of tones 0 to 255 are substituted for the constant i. By doing this, from the γ correction coefficients a, b, c, d, e, and f of each color, a one-dimensional lookup table (LUT) can be prepared.

The lookup table prepared here is the γ correction table 24 of red. Further, for green and blue, the γ correction tables 25 and 26 are prepared similarly. By doing this, the one-dimensional γ correction table as shown in FIG. 14 can be prepared. FIG. 14 shows the calibrated one-dimensional γ correction table.

FIG. 14 is a drawing showing a relation example between the scanner output value of 32 tones after the γ correction and the tones of R, G, and B. The axis of ordinate indicates the scanner output values output=0 to 255 tones. The axis of abscissa indicates the tones of R, G, and B=0 to 32 tones. The solid line indicates the characteristic of red, and the dashed line indicates the characteristic of green, and the alternate long and short dash line indicates the characteristic of blue. The characteristics of red, green, and blue, compared with FIG. 10, are not separated from each other and are overlaid on each other (arranged properly) at the high tones.

Next, at Step SA7, the control section 5 sets the calibrated γ correction tables 24, 25, and 26 in the γ correction section 30. By doing this, errors between machines and apparatuses and due to time degradation can be calibrated. In the ordinary operation mode, the scan data DR′, DG′, and DB′ passing through the γ correction tables 24, 25, and 26 are corrected in color at the matrix section by the color correction table 27 of N colors×M (3 or more, or 4, 9, 10, 27, 28).

[Calibration of Color Correction Table]

The color correction table 27 (matrix correction coefficient) can be obtained from the target data of a plurality of color patches and the scan data DR′, DG′, and DB′ (output values) passing through the γ correction tables 24, 25, and 26 from the scan section 1. With respect to the scan data DR′, DG′, and DB′, those which pass through the γ correction tables 24, 25, and 26 and are stored in the memory section 3 are used. Needless to say, R, G, and B values after re-scanning the calibration chart 10 by the scanner 100 and correcting it by the γ correction tables 24, 25, and 26 may be obtained. In this example, the R, G, and B values after γ correction are averaged and used.

At Step SA8, the CPU 55 reads the scan data DR′, DG′, and DB′ from the memory section 3 and sets them in the color correction table 27 (matrix section). In this example, without rescanning the calibration chart 10, the scan data DR′, DG′, and DB′ after γ correction from the memory section 3 are used.

And, Step SA9, the color correction table 27 is calibrated. In this example, the matrix correction coefficient is calculated on the basis of the color patch R, G, and B values read by the scanner 100 to be calibrated, target R, G, and B values, and color correction algorithm, thus the color correction table 27 is calibrated.

[Calculation of Matrix Correction Coefficient]

For example, from the color patch R, G, and B values and target R, G, and B values, the matrix correction coefficients a, b, c, d, e, f, g, h, i, j, k, and l of each color are obtained. Here, the color correction algorithm will be explained. According to the color correction algorithm, firstly, when the scan data DR′, DG′, and DB′ are 8 bits long and the color patches are represented by 125 colors, there exist R, G, and B values of 125 color patches and R, G, and B values of 125 targets.

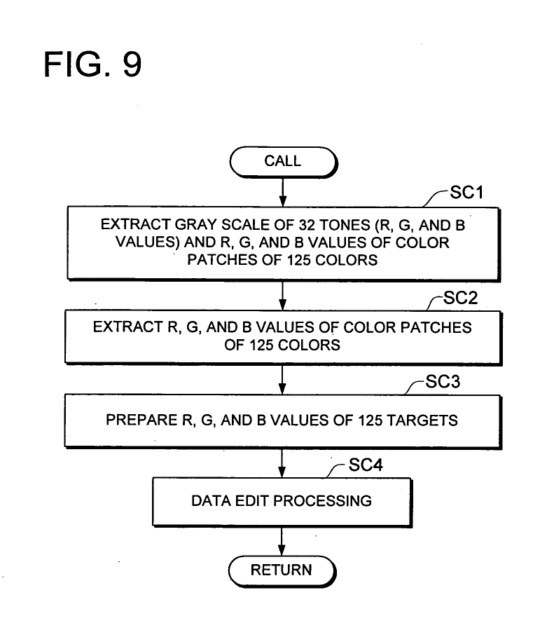

In this example, the control section 5 calls the sub-routine shown in FIG. 9 and extracts, at Step SC1 of the flow chart, the R, G, and B values of the gray scale in correspondence to 32 tones of the calibration chart 10 and the R, G, and B values of color patches of 125 colors. At this time, the control section 5 averages the brightness values of the pixels in a predetermined extraction area of the calibration chart image in the memory section, thereby obtains the R, G, and B values of each patch. The extraction areas of the chart image are indicated by the dashed lines in FIGS. 2(B) to 2(E).

Next, at Step SC2, the control section 5 takes out the R, G, and B values in correspondence to the color patches of 125 colors from the 32 tones plus the R, G, and B values of 125 colors of the calibration chart 10. The R, G, and B values of color patches of 125 colors obtained from the scanner section 1 are used for calculation for each channel for red, green, and blue.

For example, 125 red values are taken out and the 125 red channels are set as R₁, R₂, R₃, - - - , and R₁₂₅. The green channels are set as G₁, G₂, G₃, - - - , and G₁₂₅ and the blue channels are set as B₁, B₂, B₃, - - - , and B₁₂₅. The R, G, and B values of 125 color patches are expressed by Formula (9) indicated below.

$$\begin{matrix}[ Formula 9 ] & \\ ( \begin{matrix}{R}_{1} , & {R}_{2} , … , {R}_{125} \\ {G}_{1} , & {G}_{2} , … , {G}_{125} \\ {B}_{1} , & {B}_{2} , … , {B}_{125}\end{matrix} ) & ( 9 )\end{matrix}$$

Further, to the R, G, and B values of color patches of 125 colors obtained from the scanner section 1, a constant term of 1 is added. In this example, when a constant term of 1 is added to the fourth column of Formula (9), Formula (10) indicated below is obtained.

$$\begin{matrix}[ Formula 10 ] & \\ ( \begin{matrix}{R}_{1} & {R}_{2} & … & {R}_{125} \\ {G}_{1} & {G}_{2} & … & {G}_{125} \\ {B}_{1} & {B}_{2} & … & {B}_{125} \\ 1 & 1 & … & 1\end{matrix} ) & ( 10 )\end{matrix}$$

Thereafter, at Step SC3, the control section 5 prepares 125 targets and the R, G, and B values thereof. Here, for the target R, G, and B values, the mean R, G, and B values are used. In this example, the control section 5, from the X, Y, and Z values at time of colorimetric measurement which are transferred beforehand from the scanner section 1, takes out the color patch R, G, and B values. Each scan data DR, DG, and DB are fit to the target, thus the color patches can be calibrated in response to the inter-machine difference and time degradation.

To the target, for example, the target R, G, and B values obtained by averaging the R, G, and B values obtained by scanning the calibration chart 10 by a plurality of scanners are applied. Needless to say, the target is not limited to it. In this example, as X, Y, and Z values of 125 targets at time of calorimetric measurement, assuming 125 red targets as TargetR₁ to TargetR₁₂₅, similarly, 125 green targets as TargetG₁ to TargetG₁₂₅, and 125 blue targets as TargetB₁ to TargetB₁₂₅, Formula (11) indicated below is obtained.

$$\begin{matrix}[ Formula 11 ] & \\ ( \begin{matrix}{TargetR}_{1} & {TargetR}_{2} & … & {TargetR}_{125} \\ {TargetG}_{1} & {TargetG}_{2} & … & {TargetG}_{125} \\ {TargetB}_{1} & {TargetB}_{2} & … & {TargetB}_{125}\end{matrix} ) & ( 11 )\end{matrix}$$

Here, the target R, G, and B values expressed by Formula (9), the color patch R, G, and B values expressed by Formula (11), and the matrix correction coefficients a, b, c, d, e, f, g, h, i, j, k, and l are related to Formula (12), that is, the determinant indicated below.

$$\begin{matrix}[ Formula 12 ] & \\ [ \begin{matrix}Target {R}_{1} & Target {R}_{2} & … & Target {R}_{125} \\ Target {G}_{1} & Target {F}_{2} & … & Target {G}_{125} \\ Target {B}_{1} & Target {B}_{2} & … & Target {B}_{125}\end{matrix} ] = [ \begin{matrix}a & b & c & d \\ e & f & g & h \\ i & j & k & l\end{matrix} ] \cdot \\ [ \begin{matrix}{R}_{1} & {R}_{2} & … & {R}_{125} \\ {G}_{1} & {G}_{2} & … & {G}_{125} \\ {B}_{1} & {B}_{2} & … & {B}_{125} \\ 1 & 1 & … & 1\end{matrix} ] & ( 12 )\end{matrix}$$

From this determinant (12), the matrix correction coefficients a, b, c, d, e, f, g, h, i, j, k, and l are obtained. By the matrix correction coefficients, the color correction are performed for the color patches.

In this example, at Step SC4, the CPU 55 executes the data edition process and obtains the matrix correction coefficients a, b, c, d, e, f, g, h, i, j, k, and l. For example, the CPU 55 calculates Formula (12) mentioned above by the least square method and obtains the matrix correction coefficients a, b, c, d, e, f, g, h, i, j, k, and l from Formula (13) indicated below.

$$\begin{matrix}[ Fomula 13 ] & \\ [ \begin{matrix}a & b & c & d \\ e & f & g & h \\ i & j & k & l\end{matrix} ] = [ \begin{matrix}Target {R}_{1} & Target {R}_{2} & … & Target {R}_{125} \\ Target {G}_{1} & Target {G}_{2} & … & Target {G}_{125} \\ Target {B}_{1} & Target {B}_{2} & … & Target {B}_{125}\end{matrix} ] \cdot \\ [ \begin{matrix}{R}_{1} & {G}_{1} & {B}_{1} & 1 \\ {R}_{2} & {G}_{2} & {B}_{2} & 1 \\ … & … & … & … \\ {R}_{125} & {G}_{125} & {B}_{125} & 1\end{matrix} ] \cdot {[ [ \begin{matrix}{R}_{1} & {R}_{2} & … & {R}_{125} \\ {G}_{1} & {G}_{2} & … & {G}_{125} \\ {B}_{1} & {B}_{2} & … & {B}_{125} \\ 1 & 1 & … & 1\end{matrix} ] \cdot [ \begin{matrix}{R}_{1} & {G}_{1} & {B}_{1} & 1 \\ {R}_{2} & {G}_{2} & {B}_{2} & 1 \\ … & … & … & … \\ {R}_{125} & {G}_{125} & {B}_{125} & 1\end{matrix} ] ]}^{- 1} & ( 13 )\end{matrix}$$

At this time, the CPU 55 calculates the 125×3 target data (mean value) and 125×4 scan data DR′, DG′, and DB′ by the least square method and obtains 3×4 matrix correction coefficients a, b, c, d, e, f, g, h, i, j, k, and l.

Next, at Step SA10, the CPU 55 sets the calibrated color correction table 27 in the matrix section 31 (ASIC set). The γ correction tables 24, 25, and 26 and color correction table (matrix section) 27 which are obtained until now are set in the ASIC, so that the tones, color patches, and colors can be calibrated for the inter-machine difference and change with time.

Further, the scanner 100 to be adjusted is corrected by the matrix so as to be the mean R, G, and B value, thus the color patches can be calculated for the inter-machine difference and change with time. Needless to say, instead of the mean R, G, and B values of a plurality of scanners 100, the chart X, Y, and Z values may be RGB-converted by public standard XYZ to RGB conversion such as sRGB and AdobeRGB.

[Ordinary Operation Mode]

Further, when the ordinary operation mode is set at Step SA2, the CPU 55 moves to Step SA12 and discriminates whether the start instruction is input or not. At this time, when the start instruction is input to the control section 5 via the operation section 4, the CPU 55 moves to Step SA13 and executes the ordinary image reading process.

Thereafter, the CPU 55 moves to Step SA14 and discriminates the end of the ordinary operation mode or scan calibration mode. For example, when no power-off information is detected, the CPU 55 returns to Step SA1 and repeats the process of either of the ordinary operation mode and scan calibration mode on the basis of selection of the ordinary operation mode or scan calibration mode. When the power-off information is detected, both processes of the ordinary operation mode and scan calibration mode end.

As mentioned above, according to the scanner and image processing method relating to the embodiment, the R, G, and B signals obtained by reading the calibration chart 10 calibrate the color correction table 27 using the chart 10 for calibrating the γ correction and color correction tables including the gray scale and color patches. Moreover, using the scan data DR, DG, and DB obtained by one scanning, the γ correction tables and color correction tables can be calibrated and the number of times of scanning by the scanner section 1 can be reduced.

Furthermore, on the basis of the calibrated γ correction tables and the calibrated color correction tables which are reset for each scanner, the scan data DR, DG, and DB during the ordinary reading can be corrected, so that differences between machines and apparatuses including not only the gray scale but also the color patches and errors due to time degradation can be eliminated.

According to the embodiment of the present invention, the brightness tone correction table is calibrated using the image information obtained by reading the calibration sheet, and then using the calibration sheet image information corrected by using the calibrated brightness tone correction table, the color correction tables can be calibrated, and color differences between machines and apparatuses regarding the color reproducibility can be reduced, and errors due to time degradation can be reduced. Moreover, on the basis of the calibrated brightness tone correction tables and the calibrated color correction tables which are set again for each apparatus, the image information in the ordinary operation mode can be corrected, so that color differences between machines and apparatuses can be reduced, and errors due to time degradation can be reduced.

An embodiment of the present invention can be applied very preferably to a color image reading apparatus such as a color scanner, a color facsimile device, a digital camera, and a color composite device for γ-correcting, color-correcting, and outputting R, G, and B color image signals obtained by reading a color image.

What is claimed is:

1. An image reading apparatus, comprising:
an image reading section which scans a calibration sheet for calibration and reads image information thereof; and
a correction section which calibrates a brightness tone correction table based on the image information read from the calibration sheet by the image reading section, corrects image information of the calibration sheet using the calibrated brightness tone correction table and calibrates a color correction table based on the corrected image information.

2. The image reading apparatus of claim 1, comprising:
a memory section for storing the image information which has been read by the image reading section and has been used for calibrating the brightness tone correction table,
wherein when calibrating the color correction table, the correction section corrects the image information of the calibration sheet read out from the memory section using the calibrated brightness tone correction table.

3. The image reading apparatus of claim 1, wherein the calibration sheet includes a chart which contains a gray scale and a color patch, and the correction section calibrates the brightness tone correction table based on brightness information obtained by reading the gray scale and calibrates the color correction table based on color image information obtained by reading the color patch.

4. The image reading apparatus of claim 1, comprising:
an control section which sets the calibrated brightness tone correction table and the calibrated color correction table and controls the correction section,
wherein the correction section corrects image information which is read when ordinarily reading using the calibrated brightness tone correction table and the calibrated color correction table which are set by the control section.

5. An image processing method, comprising the steps of:
calibrating a brightness tone correction table based on image information obtained by reading a calibration sheet for calibration;
correcting image information of the calibration sheet using the calibrated brightness tone correction table; and
calibrating a color correction table based on the corrected image information.

6. The image processing method of claim 5, wherein the calibration sheet includes a chart which contains a gray scale and a color patch,
in the step of calibrating the brightness tone correction table, calibrating the brightness tone correction table based on brightness information obtained by reading the gray scale,
in the step of calibrating the color correction table, calibrating the color correction table based on color image information obtained by reading the color patch.

7. The image processing method of claim 5, comprising the steps of:
setting the calibrated brightness tone correction table and the calibrated color correction table; and
correcting image information which is read when ordinarily reading using the set brightness-tone correction table and the set color correction table.

8. A computer-readable recording medium storing a program for making a computer execute a process, the process comprising the steps of:
calibrating a brightness tone correction table based on image information obtained by reading a calibration sheet for calibration;
correcting image information of the calibration sheet using the calibrated brightness tone correction table; and
calibrating a color correction table based on the corrected image information.
